(19) United States
(12) Patent Application Publication
(10) Pub. No.: US 2009/0169890 A1
(43) Pub. Date: Jul. 2, 2009

(54) High Brightness and Low Abrasion Calcined Kaolin

(76) Inventors: Robert J. Pruett, Milledgeville, GA (US); Ismail Yildirim, Milledgeville, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/158,120

(22) PCT Filed: Dec. 18, 2006
(86) PCT No.: PCT/US06/47898

§ 371 Date: Oct. 16, 2008

Related U.S. Application Data
(60) Provisional application No. 60/752,031, filed on Dec. 21, 2005.

(51) Int. Cl. C01B 33/26; B32B 5/16; B32B 9/06

(52) U.S. Cl. 428/402; 423/328.2; 428/452

(57) ABSTRACT

Disclosed herein are calcined kaolins, having a GE brightness of at least about 89 and an Einlehner Abrasion value of not more than about 4.0 mg when measured at 43.5 krev and a solids content of 10%. Further disclosed herein are calcined kaolins, having a Hunter “a” value of less than 0.1 and an Einlehner Abrasion value of not more than about 4.0 mg when measured at 43.5 krev and a solids content of 10%. In addition, disclosed herein are methods of making the calcined kaolins and products comprising the calcined kaolins.

This application claims priority to U.S. Provisional Patent Application No. 60/752,031, filed on Dec. 21, 2005

Disclosed herein are high brightness and low abrasion calcined kaolins and methods of making the calcined kaolins. The calcined kaolins as disclosed herein can have many uses, for example, papermaking, such as paper coating and filling, paints, plastics, polymers, ceramics, and coating compositions.

Particulate kaolins occur naturally in the hydrous form and exist as crystalline structures containing at least one hydroxyl functionality. Particulate kaolins may be converted to a calcined form by thermal processes. Such processes cause the particulate kaolin to dehydroxylate. During calcination, the hydrous kaolin converts from a crystalline to an amorphous form.

The calcination of kaolins usually requires high temperatures, for example, a temperature of higher than about 400° C., such as ranging from about 500° C. to about 1250° C.

High brightness and low abrasion are often desired properties of the pigments used in various industries, such as papermaking. However, conventional calcined kaolins do not have desired high brightness, such as a GE brightness of at least about 89, and desired low abrasion, such as an Einlehner Abrasion value of no more than about 4.0 mg when measured at 43.5 krev and a solids content of 10%. Some conventional calcined kaolins may have the desired high brightness, but lack the desired low abrasion. For example, the metakaolin disclosed in U.S. Pat. No. 5,393,340, whose Einlehner Abrasion value is higher than about 4.0 mg when measured at 43.5 krev and a solids content of 10%. On the other hand, some conventional calcined kaolins may have the desired low abrasion, but lack the desired high brightness.

Accordingly, there remains a need for calcined kaolins having both the desired high brightness and low abrasion. The present inventors have surprisingly discovered novel high brightness and low abrasion calcined kaolins, having a GE brightness of at least about 89 and an Einlehner Abrasion value of no more than about 4.0 mg when measured at 43.5 krev and a solids content of 10%, using the calcination process disclosed herein.

GE Brightness, as used herein, is defined in TAPPI Standard T457 and refers to the percentage reflectance to light of a 457 nm wavelength according to methods well known to those of ordinary skill in the art.

Einlehner Abrasion, as used herein, is measured using an Einlehner abrader as follows:

100 g of a sample is weighed and mixed with 900 ml of deionized water to form a slurry. The pH of the slurry is adjusted to about 7.0 using 5% of tetrasodium pyrophosphate (TSPP) solution. The slurry is then mixed for 10 minutes in a mixer. The resulting slurry is poured into a rotary Einlehner abrader and is rotated at the setting of 174 krev. The difference of the weight (i.e., the weight loss) of the screens in the abrader before the test and after the test is measured and calculated. The weight loss at 174 krev is divided by 4 to determine the weight loss at 43.5 krev, which is the recorded value for abrasion. Such weight loss is the Einlehner Abrasion value of the sample.

### BRIEF DESCRIPTION OF THE DRAWINGS

FIG. 1 is a graphical representation of light scattering properties of the filled paper as a function of ash level for a (1) regular Alphatex, (2) inventive calcined kaolin, and (3) regular Opacitex as compared in Example 2.

FIG. 2 is a graphical representation of opacity of the filled paper as a function of ash level for a (1) regular Alphatex, (2) inventive calcined kaolin, and (3) regular Opacitex as compared in Example 2.

FIG. 3 is a graphical representation of brightness of the filled paper as a function of ash level for a (1) regular Alphatex, (2) inventive calcined kaolin, and (3) regular Opacitex as compared in Example 2.

The calcined kaolins disclosed herein can be chosen, for example, from those having a GE brightness of greater than about 89.5, such as greater than about 90, further such as greater than about 90.5, even further such as greater than about 91. In one embodiment, the calcined kaolins disclosed herein have a GE brightness of greater than about 91.5, such as greater than about 92.

Further, the calcined kaolins disclosed herein can be chosen, for example, from those having an Einlehner Abrasion value of no more than about 3, such as no more than about 2. In one embodiment, the calcined kaolins disclosed herein have an Einlehner Abrasion value of no more than about 1.7

The chromaticity of the calcined kaolins disclosed herein is assessed with Hunter L, a, b coordinates, where components a, b, and L are the color component values on the color space scale as measured by a Hunter Ultrascan XE instrument. “+a” is a measure of red tint; “−a” is a measure of green tint; “+b” is a measure of yellow tint; “−b” is a measure of blue tint; “L” is a measure of whiteness. As used herein, the lower “a” value is (i.e., the more negative), the lower “b” value is, and/or the higher “L” value is (i.e., the closer to 100), the better quality of the calcined kaolins.

The calcined kaolins disclosed herein may have an “a” value, for example, of less than about 0.1, such as less than 0, further such as less than about −0.1, and even further such as less than about −0.2. They may have a “b” value, for example, of less than about 4.0, such as less than 3.5, and further such as less than about 3.0.

Further, the calcined kaolins disclosed here may have an “L” value, for example, of higher than about 96, such as higher than about 97.

In one embodiment, the calcined kaolins disclosed here have an “a” value of less than about 0.1 and an Einlehner Abrasion value of no more than about 4.0 mg when measured at 43.5 krev and a solids content of 10%.

The calcined kaolins disclosed herein are fine particles, having a particle size distribution (PSD), for example, of over 90% particles with an equivalent spherical diameter (ESD) of less than about 2 μm. In one embodiment, the calcined kaolins disclosed herein have a median particle size (D50) of less than 1 μm. In another embodiment, the calcined kaolins disclosed herein have a D50 of less than 0.1 μm. The PSD can be determined by measuring the sedimentation of the particulate product in a fully dispersed condition in a standard aqueous medium, such as water, using a SEDIGRAPH™ instrument, e.g., SEDIGRAPH 5100, obtained from Micromeritics Corporation, USA. The ESD of a given particle is expressed in terms of the diameter of a sphere of equivalent diameter, which sediments through the medium. The SEDIGRAPH graphically records the percentage by weight of particles having an ESD less than a particular ESD value.

Further disclosed herein are methods of making the calcined kaolins disclosed herein, comprising

(a) coating at least a portion of a kaolin with a fuel composition comprising a liquid fuel to form a coated kaolin; and

(b) heating the coated kaolin to calcine the kaolin and to burn the liquid fuel to form the calcined kaolin.

The crude kaolin, i.e., the kaolin feed, has a fine particle size distribution, for example, about 95-100% of particles with an ESD of less than about 1 μm, such as about 80-90% of particles with an ESD of less than about 0.5 μm. The kaolin feed disclosed herein has a GE brightness of at least about 75, such as at least about 85, a Fe₂O₃ content of about 0.1-1.0% by weight, such as about 0.7-0.9% by weight, and a TiO₂ content of about 0.1-2.5% by weight, such as about 1.3-1.6% by weight.

The kaolin feed may be chosen, for example, from gray, soft, and hard clays. Any type of crude kaolins could be used. For example, fine and ultrafine kaolin clays occurring in primary, secondary or tertiary deposits could be suitable for making the calcined kaolin as disclosed here.

Coating at least a portion of the particulate material with the fuel composition comprising a liquid fuel can provide additional energy for heating the feed. The kaolins can be heated directly, e.g., via heat provided by a kiln, and indirectly via heat generated by burning the liquid fuel. As a result, the calcination can be performed at lower temperatures due to the synergistic effect arising from the use of liquid fuel that coats the kaolins. Accordingly, overall thermal energy requirements for the calcination can be reduced.

The use of a liquid fuel can also be beneficial as a secondary source of heat when compared to solid fuels. For example, liquid fuel can provide a higher heat value than solid fuels. At a given addition rate, fuel oil can yield more heat than any other solid fossil fuel source, such as charcoal, sawdust, organic sludge, and the like. Moreover, the use of liquid fuels, such as hydrocarbons, does not result in the production of ash, which may cause discoloring of the calcined product.

The liquid fuel can be spread throughout the kaolin more homogeneously compared to solid fuels, via coating. As used herein, “coating” refers to coating at least a portion of the accessible outer surface of a kaolin, whether it exists as aggregates (if present in the kaolin), or at least a portion of the surface of individual particles.

As used herein, “liquid fuel” refers to a fuel that is a liquid at operating temperatures. For example, a fuel may be a solid at room temperature but is sufficiently liquid at the time of mixing with the kaolin for the coating.

The term “at least a portion of the kaolin” refers to at least about 50% of the kaolin being coated with liquid fuel. At least about 60% of the kaolin may, for example, be coated with liquid fuel, such as at least about 75%, further such as at least about 80%, even further such as at least about 90%. In one embodiment, at least about 95% of the kaolin is coated with liquid fuel. The adsorption density of liquid fuel on the kaolin (or the percentage of particle surface coated with liquid fuel) can be determined qualitatively and quantitatively by a variety of experimental methods such as BET, FTIR, XPS, differential thermal analysis, thermogravimetric analysis, analysis of VOC's and hydrocarbons, oil absorption testing, inverse gas chromatography, flash point testing, microcalorimetry, differential scanning calorimeter, etc.

The liquid fuel may be present in relatively small amounts to achieve the synergistic effect. In one aspect, the liquid fuel is present in the feed mixture in an amount ranging from about 0.01% to about 4% by weight, relative to the total weight of the feed mixture. In another aspect, the liquid fuel is present in the feed mixture in an amount ranging from about 0.01% to about 1% by weight, relative to the total weight of the feed mixture.

The liquid fuel may be an organic material. In one embodiment, the liquid fuel comprises a hydrocarbon oil. Exemplary hydrocarbon oils include fuel oils, vegetable oils, modified vegetable oils, waste oils, aliphatic and aromatic alcohols, and biodiesels.

Exemplary fuel oils include kerosene, petroleum, mineral oil, turpentine, gasoline, diesel, No. 2 fuel oil, No. 4 fuel oil, No. 5 light fuel oil, No. 5 heavy fuel oil, and No. 6 fuel oil. Representative vegetable oils include canola oil, soybean oil, corn oil, palm oil, olive oil, sunflower oil, cottonseed oil, peanut oil, sesame oil and safflower oil. The vegetable oils can comprise one or more fatty acids. The modified vegetable oils can be chosen, for example, from methyl-, ethyl-, propyl-, butyl, (or higher alkyl) esters of canola oil, soybean oil, corn oil, palm oil, olive oil, sunflower oil, cottonseed oil, peanut oil, sesame oil and safflower oil. Exemplary waste oils include industrial and domestic waste oils, such as waste fat and grease oil, used motor oil, and biodiesels of waste oils.

In one embodiment, coating/mixing of calcine feed material with the liquid fuel can increase the density of the bed material that is heated, and thus, may improve calcination.

Coating the kaolin with the fuel may be conducted, for example, in a mixer. A high or low intensity mixer can be used for mixing/coating the kaolin feed with the fuel before the heating/calcining in (b). One example of the high intensity mixer is a Gunter Papenmeier GmbH & Co, Detmold, Germany, Model No: TGAHK 8, ID Number: 4564, which has an 8-liter capacity, stainless steel jacketed bowl with two stage mixing blades rotating from the bottom of the vessel. The rotational speed of mixing blades can be as high as about 4,000 rpm. The rotational speed during coating may range, for example, from about 2,000 to about 3,500 rpm, such as about 3,000 rpm. The kaolin and the fuel in the mixer may, for example, be subjected to a tip speed of less than about 10,000 feet per minute. The mixer provides homogenous hydrocarbon oil distribution on the surface of individual feed particles or aggregates. Other kinds of high intensity mixers, such as Turbulizer™, Ross® Planetary mixer, may also be used in a continuous or batch application. In the production scale, regular screw feed auger or a modified screw feed auger may be used for mixing/coating the liquid fuel with the clay particles.

The coating time typically ranges from about 5 seconds to about 10 minutes, such as from about 3 to about 6 minutes, further such as about 5 minutes.

The coated feed kaolin may, for example, be metered to a calciner through a screw feeder for calcination.

As used herein, “calcined kaolin” refers to a kaolin that has been converted from the corresponding (naturally occurring) hydrous kaolin to the dehydroxylated form by thermal methods. Calcination can change, among other properties, the kaolin structure from crystalline to amorphous. Calcination is affected by heat-treating coarse or fine hydrous kaolin in any known manner, e.g., at temperatures ranging from about 400° C. to about 1250° C., such as from about 500° C. to about 1200° C.

The degree to which hydrous kaolin undergoes changes in crystalline form depends upon, for example, the amount of heat to which the hydrous kaolin is subjected. Initially, dehydroxylation of the hydrous kaolin can occur upon exposure to heat. At temperatures below a maximum of about 850-900° C., such as from about 450° C. to about 650° C., the product is often considered to be partially dehydroxylated, with the resultant amorphous structure commonly referred to as a metakaolin. In one embodiment, the calcined kaolin disclosed herein is metakaolin. Frequently, calcination at this temperature is referred to as “partial calcination,” and the product may also be referred to as “partially calcined kaolin.” Further heating to temperatures above about 900-950° C. can result in further structural changes, such as densification. Calcination at these higher temperatures is commonly referred to as “full calcination,” and the product is commonly referred to as “fully calcined kaolin.” The calcined kaolin disclosed herein can be chosen from fully calcined kaolins and partially calcined kaolins.

Heating the coated kaolin in (b) refers to any of the calcination processes discussed above. Heating to a temperature can comprise heating the coated kaolin at one temperature only, at two or more different temperatures, or over a range of temperatures. The heating can occur for a time to partially or fully calcine the kaolin depending on the heating time and temperature, e.g., the heating in (b) is carried out for a sufficient time to at least partially calcine or to fully calcine the coated kaolin.

In one embodiment, the coated kaolin may be heated to a temperature ranging from about 900° C. to about 1200° C., such as from about 950° C. to about 1150° C., further such as from about 1000° C. to about 1100° C.

Additional calcination may cause formation of mullite. Mullite concentrations can range, for example, from about 2% to about 3% by weight, relative to the total weight of the resulting calcined product, and may be useful in some end-use applications, such as ceramic catalyst substrates, e.g., cordierite substrates. Mullite may also be present in an amount ranging, for example, from greater than about 2%, such as greater than about 5%, and further such as greater than about 8%, by weight relative to the total weight of the resulting calcined product, such that they may be useful in some end-use applications.

Effective calcining procedures include, for example, soak calcining and flash calcining. In soak calcining, a hydrous kaolin is heated at temperatures ranging from 500° C. to 1200° C., such as from 800° C. to 1200° C., further such as from 850-900° C., and even further such as from 900-950° C., as described herein, for a period of time (e.g., from at least about 1 minute to about 5 or more hours) sufficient to dehydroxylate the kaolin. In flash calcining, a hydrous kaolin is heated rapidly for a period of less than 1 second, typically less than 0.5 second.

The calciners that may be used for the heating include, for example, horizontal rotary kilns, tunnel kilns, vertical calciners, and flash calciners. The furnace, kiln, or other heating apparatus used to effect calcining of the kaolin feed may be of any known kind. For example, the heating in (b) is performed with at least one of a rotary kiln, a vertical kiln, a flash kiln and a tunnel kiln. Known devices suitable for carrying out soak calcining include, for example, high temperature ovens and rotary and vertical kilns. Known devices for effecting flash calcining include, for example, toroidal fluid flow heating devices, such as those described in WO 99/24360, the disclosure of which is incorporated by reference herein.

It is possible for the calcined kaolin product from (b) to have a GE brightness comparable to or even greater than the GE brightness of a kaolin product calcined from an uncoated hydrous kaolin, as similar GE brightness calcined kaolins can be achieved at lower calcining temperatures using the method disclosed herein. For example, the calcining temperature required for a liquid fuel coated hydrous kaolin is at least about 50° C. less than the calcining temperature for an uncoated hydrous kaolin, such as a calcining temperature of about 100-150° C. less than the calcining temperature for an uncoated hydrous kaolin. These lower temperatures assume comparable samples of hydrous kaolin and the same extent of calcining (e.g., full calcination, partial calcination, etc.).

Prior to the heating in (b), the kaolin can be subjected to one or more well known beneficiation steps to remove undesirable impurities. For example, an aqueous suspension of kaolin clay may be subjected to a froth flotation treatment operation to remove titanium containing impurities in the froth. The slurry can be conditioned with an oleic acid to coat the air bubbles produced in the float cells. The titania minerals adhere to the air bubbles and are floated out of the kaolin slurry. An example of such a flotation process is described in U.S. Pat. No. 3,450,257, to Cundy, which is herein incorporated by reference. This process can result in an improved brightness in the kaolin pigment, e.g., a GE brightness gain ranging from about 0.1 to about 3 units.

Alternatively, or in addition, the kaolin may be passed as a suspension through a high intensity magnetic separator to remove iron containing impurities, prior to the heating in (b). A standard high intensity wet magnetic separator can be used. This process can also result in a brightness gain ranging from about 0.1 to about 3.0 units.

Also optionally, the kaolin can be subjected to a selective flocculation process prior to the heating in (b) in which the impurities are flocced out of suspension while the kaolin clay remains in suspension. In one example, a high molecular weight anionic polymer having a molecular weight in excess of one million, or a molecular weight in the range of about 10 to about 15 million can be used. The anionic polymer can be a copolymer of a polyacrylamide or polyacrylate. The refined clay slurry may be ozoned, leached (bleached), and/or filtered. The clay may then be acid flocculated and dried, or may be redispersed in a makedown tank and alternately spray dried. Details of a selective flocculation process can be found in U.S. Pat. No. 4,227,920 to Chapman and Anderson, in which the disclosure at col. 3, lines 19-34 and at col. 4, lines 3-16 is incorporated herein by reference for its teachings of a selective flocculation process. U.S. Pat. No. 5,685,900 to Yuan et al., includes a description of an ozonation process, in which the disclosure at col. 3, line 62 to col. 4, line 7, col. 5, lines 12-26 is incorporated herein by reference for its teachings of an ozonation process.

It has at times proven advantageous to add additives, such as TiO₂, to particulate kaolins, prior to calcination to improve the opacity and light scattering characteristics of the calcined kaolin. However, hydrophobic additives, such as TiO₂, can floc and form aggregates when added to aqueous suspensions of particulate kaolins, leading to less than ideal dispersion to the surface of the calcined kaolin, reducing its beneficial effects on opacity and light scattering.

The present inventors have surprisingly discovered that use of the at least one additive together with the liquid fuel disclosed here for coating kaolins can improve the dispersion of the at least one additive to the surface of the kaolins. The at least one additive can also be sintered to the surface of the kaolin during calcination, preventing later separation and/or segregation of the kaolin and the additive and increasing retention of the additive. In another aspect, chemical additives coated onto the surface of the kaolin can react during calcination to modify the surface chemistry of the kaolin. Thus, the fuel disclosed herein may further comprise at least one additive.

In one embodiment, the method discloses herein comprises:

(a) combining at least one additive in a liquid fuel to form an additive/liquid fuel mixture;

(b) coating at least a portion of a kaolin with a fuel composition comprising the additive/liquid fuel mixture to form a coated kaolin; and

(c) heating the coated kaolin to calcine the kaolin and burn the liquid fuel to form the calcined as disclosed herein.

The additive/liquid fuel mixture can be in any form, such as a slurry or suspension. For example, the combining in (a) may comprise dispersing the at least one additive in the liquid fuel to form an additive/liquid fuel dispersion. Further, the combining can, for example, be performed in the presence of dispersants to maintain a suspension.

The at least one additive can include, for example, minerals chosen from TiO₂, zirconia, silica such as diatomaceous earth, silica, aluminum trihydrate, calcium oxide, magnesium oxide, and calcium carbonate such as precipitated calcium carbonate (PCC), and ground calcium carbonate (GCC). In one embodiment, the at least one additive is chosen to optimize the light scattering properties (e.g., opacity) of the resulting calcined product.

The at least one additive may be present in an amount ranging, for example, from about 0.1% to about 10% by weight of the feed material to be calcined. The particle size distribution of solid additives may ranges from about 100 nanometer to about 2-3 micron in diameter measured using either SEDIGRAPH 5100 or light scattering. Adding such additives into the feed material may, for example, increase the brightness of the calcined product, improve light scattering properties and retention of filler and paper fiber during paper making, etc.

The calcined kaolin disclosed herein can be used for a variety of applications where increased opacity, brightness, and low abrasion are desired. For example, the calcined kaolin disclosed herein can be used in the manufacture paper and paperboard products, paper coatings, ceramic products, paints, polymers, rubbers, and inks.

Disclosed herein is a coating, such as a non-aqueous coating for paper or paperboard, comprising the calcined kaolin disclosed herein. The coating can further comprise at least one binder chosen from binders conventionally used in the art. Exemplary binders include, but are not limited to, adhesives derived from natural starch and synthetic binders, including, for example, styrene butadiene, acrylic latex, vinyl acetate latex, or styrene acrylic, casein, polyvinyl alcohol, polyvinyl acetate, or mixtures thereof.

The coating may optionally comprise other additives, including, but not limited to, dispersants, cross linkers, water retention aids, viscosity modifiers or thickeners, lubricity or calendering aids, antifoamers/defoamers, gloss-ink hold-out additives, dry or wet rub improvement or abrasion resistance additives, dry or wet pick improvement additives, optical brightening agents or fluorescent whitening agents, dyes, biocides, leveling or evening aids, grease or oil resistance additives, water resistance additives and/or insolubilizers.

Paper coatings may have different binder levels depending upon the type of printing to be used with the coated paper product. Appropriate binder levels based upon the desired end product would be readily apparent to the skilled artisan. Binder levels are controlled to allow the surfaces to receive ink without disruption. The latex binder levels for paper coatings generally range from about 3% to about 30%, such as from about 10% to about 30% by weight relative to the total weight of the coating. Paper or paper board coatings may comprise the calcined kaolin disclosed herein in an amount ranging from about 3% to about 95% by weight on a dry coating basis.

In addition, disclosed herein is a feed for a ceramic, comprising the calcined kaolin as described herein. The ceramic can be used for supporting a catalyst, e.g., such as a catalyst used in a catalytic converter. In one embodiment, the ceramic comprises the catalyst.

The invention will be further clarified by the following non-limiting examples, which are intended to be purely exemplary.

### EXAMPLE 1

This Example provides comparative data for the calcined kaolin according to the present disclosure and the calcined kaolins not according to the present disclosure. Regular Alphatex, which is not according to the present disclosure, was made by calcining the Alphatex feed material at 2,050-2,150° F. in the vertical Herschaff kilns to obtain a 92-92.7 GE brightness and 5.5-8 mg abrasion at 43.5 krev. The inventive calcined kaolin was made by coating the same Alphatex feed material with 30 lbs/ton of fuel oil for 10 minutes in a Ross® Planetary mixer at a 4.5 speed setting and then calcining the coated calcine in a laboratory muffle furnace at 900° C. (i.e., 1,652° F.) for 30 minutes. The fuel oil used was a standard No. 2 diesel fuel oil. The inventive calcined kaolin was pulverized once after calcining and its properties were measured. Regular Opacitex, which is not according to the present disclosure, was made by calcining the Opacitex feed material in a laboratory muffle furnace at 900° C. (i.e., 1,652° F.) for 30 minutes. It was then pulverized once and its properties were measured.

The Opacitex feed material is coarser and has higher impurities (i.e., higher weight percentage of discolored TiO₂ and iron oxides) than the Alphatex feed material, as shown in the table below:

| | | Alphatex | |
|---|---|---|---|
| | | Feed | |
| | | for Regular Alphatex | Opacitex |
| | | and Inventive | Feed for Regular |
| Sample | | Calcined Kaolin | Opacitex |
| GE Brightness | | 82.60 | 80.50 |
| L | | 92.59 | 91.63 |
| a | | −0.24 | −0.20 |
| b | | 3.23 | 3.49 |
| TiO₂, % | | 1.52 | 2.02 |
| Fe₂O₃, % | | 0.83 | 0.87 |
| PSD | | | |
| <10 | μm, % | 100.1 | 98.5 |
| <5 | μm, % | 99.9 | 95.3 |
| <2 | μm, % | 99.9 | 88.3 |
| <1 | μm, % | 88.1 | 81.1 |
| <0.5 | μm, % | 88.5 | 69.3 |
| <0.25 | μm, % | 62.2 | 46.2 |

Table I below shows the properties of the regular Alphatex, the regular Opacitex, and the inventive calcined kaolin, as indicated by the following data: GE Brightness, Hunter L, a, b coordinates, particle size distribution (PSD), and Einlehner Abrasion values.

TABLE I

| | | | |
|---|---|---|---|
| | | | Inventive |
| | Regular | Regular | Calcined |
| Sample | Alphatex | Opacitex | Kaolin |

| GE Brightness | | 92.4 | 83.14 | 90.1 |
|---|---|---|---|---|
| L | | 97.41 | 94.47 | 97.01 |
| a | | 0.00 | 0.43 | −0.11 |
| b | | 2.11 | 5.19 | 3.55 |
| PSD | | | | |
| <10 | μm, % | 100 | 99.7 | 99.8 |
| <5 | μm, % | 99 | 96.8 | 98.9 |
| <2 | μm, % | 94 | 87.1 | 95.1 |
| <1 | μm, % | 88 | 75.2 | 87.9 |
| <0.5 | μm, % | 56 | 43.7 | 58.5 |
| <0.25 | μm, % | 12 | 13.1 | 7.9 |

| | | | |
|---|---|---|---|
| Einlehner Abrasion | 6.2 | 5.1 | 2.9 |
| (mg/43.5 krev) | | | |

As shown in Table I, the inventive calcined kaolin has a higher GE brightness but lower Einlehner Abrasion value than the regular Opacitex. Further, the inventive calcined kaolin has a much lower “a” value and a lower “b” value than the regular Opacitex, indicating that the inventive calcined kaolin has better optical properties than the regular Opacitex. In addition, the inventive calcined kaolin has a much lower Einlehner Abrasion value and a similar or better “a” value than the regular Alphatex.

The inventive calcined kaolin was obtained using the same Alphatex feed material and calcining at a 400-500° F. lower temperature than the regular Alphatex. As the result, the abrasion value of the inventive calcined kaolin is more than 50% lower than the regular Alphatex, whereas the GE brightness of the inventive calcined kaolin is only slightly lower than the regular Alphatex, i.e., 90.1 vs. 92.4.

### EXAMPLE 2

To test the utility of the inventive calcined kaolin as a filler, handsheets were prepared from a unbleached natural Kraft which has subjected to no refining. While the present example pertains to use as a paper filler, it is anticipated that the inventive kaolins could also be useful as a high opacity filler for plastics and like materials.

The handsheets were made with a TAPPI sheet mold at a pH of 4.5. The sheets were made on a fourdinier paper machine using unbleached hardwood kraft. The conditions are discussed below

| | |
|---|---|
| pH | 6.75 |
| Freeness (CSF) | 470 |
| Freeness (CSF) after beating | 380 |
| Britt Fines | |
| % Fiber | 80.3 |
| % Fines | 18.9 |
| % Ash | 0.8 |
| Brightness | 22.7 |
| Specific Conductivity | 1750 |
| Mutek PCD: | −340 |
| Total Dissolved Solids | 2327 ppm |
| Inorganic Dissolved | 1880 ppm |

The handsheets were air dried and properties, i.e., light scatter, opacity, and brightness, were measured for sheets made using the regular Alphatex and regular Opacitex, and sheets made using the inventive calcined kaolin, as described in Example 1 above, as fillers therein. All sheets included 2 lbs per ton of a commercially available retention aid of a sort that would be readily obtainable by one of ordinary skill in the art.

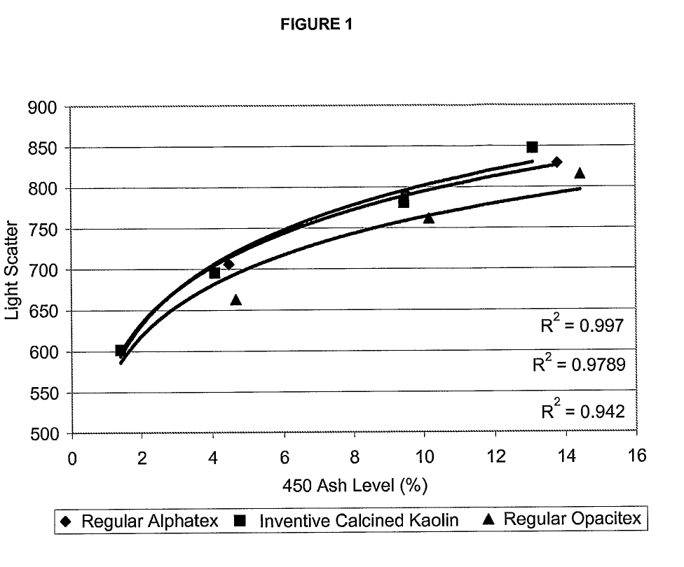

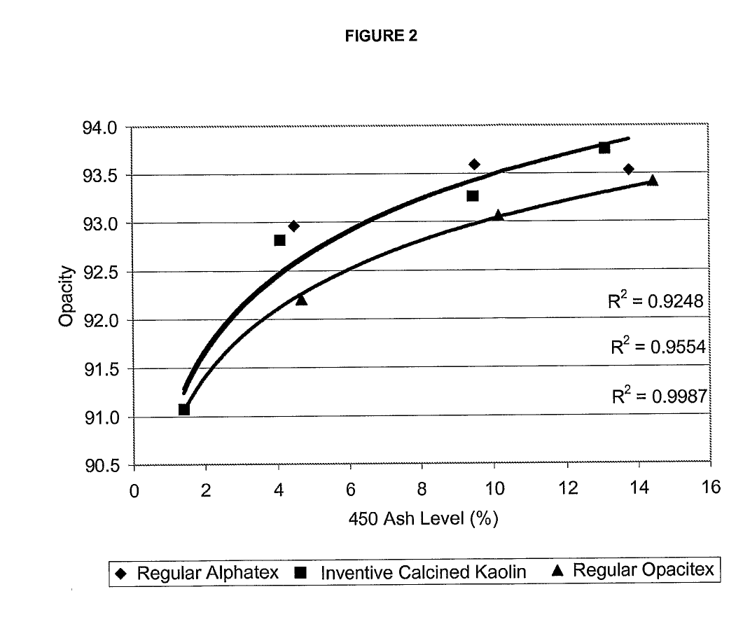

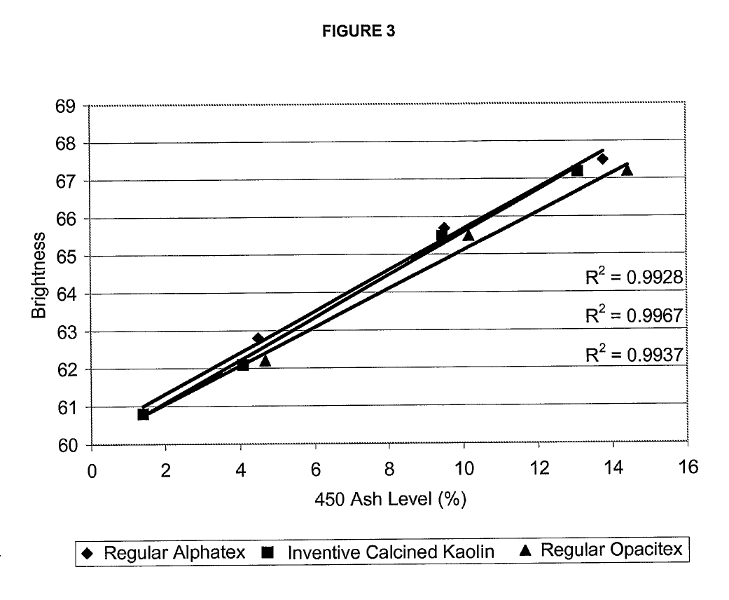

The results of the properties are shown in FIGS. 1, 2, and 3. As shown in FIGS. 1-3, the sheets made using the inventive calcined kaolin as fillers have similar properties, i.e., light scatter, opacity, and brightness, as the sheets made using the regular Alphatex as fillers, while better than the sheets made using the regular Opacitex as fillers.

### EXAMPLE 3

This Example provides another set of data for comparison of the inventive calcined kaolins according to the present disclosure and calcined kaolins not according to the present disclosure, which were calcined at different temperatures with and without standard No. 2 diesel fuel oil as the calciner feed additive. In this example, similar to Example 1, two different calcine feeds were used, i.e., the Alphatex feed for the regular Alphatex and the inventive calcined kaolin, and the Opacitex feed for the regular Opacitex. Their physical properties after calcinations were compared.

Table II below shows the results of GE Brightness, Hunter L, a, b coordinates, and Einlehner Abrasion values for the inventive calcined kaolins calcined at two different temperatures (i.e., 871° C. and 900° C.) and the regular Opacitex that is calcined at 871° C. In Table II, the inventive calcined kaolin was also compared at 871° C. kiln temperature to determine the advantage of using fuel oil as the calciner feed additive. All the calcine tests shown in Table II were performed in the lab muffle furnace for 30 minutes at a given test condition (i.e., kiln temperature or fuel oil addition).

TABLE II

| | | | | Regular |
|---|---|---|---|---|
| | (Control) | (Inventive) | (Inventive) | Opacitex, |
| | Calcined Kaolin, | Calcined Kaolin, | Calcined Kaolin, | @ 871° C., |
| | @ 871° C., without | @ 871° C., with 30 | @ 900° C., with 30 | without fuel |
| Sample | fuel oil | lbs/ton fuel oil | lbs/ton fuel oil | oil |
| GE Brightness | 87.79 | 89.35 | 91.61 | 82.57 |
| L | 96.42 | 96.88 | 97.45 | 94.37 |
| a | 0.26 | −0.05 | −0.26 | 0.54 |
| b | 4.36 | 3.80 | 2.96 | 5.36 |
| Einlehner | 1.7 | 1.8 | 2.3 | 4.1 |
| Abrasion | | | | |
| (mg/43.5 krev) | | | | |

As shown in Table II, the fuel oil coated inventive calcined kaolin yields a better GE brightness, L, “a” and “b” value at 871° C. kiln temperature than the control calcined kaolin, while the abrasion value of the calcined kaolins was similar for the fuel oil coated and uncoated samples. Increasing the kiln temperature from 871° C. to 900° C. in the presence of fuel oil further increases the product's GE brightness from 89.35 to 91.61. The temperature change also results in improvement in L, “a” and “b” values and slight increase in product's abrasion value.

Also as shown in Table II, the inventive calcined kaolin had significantly better optical properties as reflected in GE Brightness, L, “a” and “b” values and lower abrasion values than the regular Opacitex, which is not according to the present disclosure.

### EXAMPLE 4

In this Example, the regular Alphatex feed was calcined in the product kiln. The production in the kiln was a continuous process over a period of 8 hours with the regular Alphatex feed being added at one end and the product removed at the other end. Inventive calcined kaolin is a calcined product of the regular Alphatex kaolin clay feed that was calcined in a vertical Herschaff kiln at an average of 1835° F. The regular Alphatex kaolin clay feed was coated and mixed with 6.0 pounds/ton of fuel oil in a modified screw feed auger. The fuel oil used was a standard No. 2 diesel fuel oil and with a flow rate of 0.05 gallon per minute (GPM). The feed rate to the kiln was kept at 3.5 tons per hour. At 1, 2, 4, 5, 6, 7, and 8 hours, GE Brightness and Hunter L, a, b coordinates of the sample were measured and recorded, with an average shown in Table III. At 2, 5, 6, 7, and 8 hours, Einlehner Abrasion of the sample was measured and recorded, with an average shown in Table III. At 2, 4, 5, 6, 7, and 8 hours, pH and particle size distribution (PSD) were measured and recorded, with an average shown in Table III.

TABLE III

| | |
|---|---|
| | Inventive Calcined |
| Sample | Kaolin |

| GE Brightness | | 89.91 |
|---|---|---|
| L | | 96.75 |
| a | | 0.08 |
| b | | 3.17 |
| Einlehner Abrasion | | 3.8 |
| (mg/43.5 krev) | | |
| pH | | 5.47 |
| PSD | | |
| <10 | μm, % | 99.6 |
| <5 | μm, % | 97.9 |
| <2 | μm, % | 91.7 |
| <1 | μm, % | 84.6 |
| <0.5 | μm, % | 46.2 |

Other aspects of the invention will be apparent to those skilled in the art from consideration of the specification and practice of the invention disclosed herein. It is intended that the specification and examples be considered as exemplary only, with a true scope and spirit of the invention being indicated by the following claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

What is claimed is:

1. A calcined kaolin, having a GE brightness of at least about 89 and an Einlehner Abrasion value of not more than about 4.0 mg when measured at 43.5 krev and a solids content of 10%.

2. The calcined kaolin according to claim 1, having a GE brightness of at least about 89.5.

3. The calcined kaolin according to claim 2, having a GE brightness of at least about 90.

4. The calcined kaolin according to claim 3, having a GE brightness of at least about 91.

5. The calcined kaolin according to claim 1, having an Einlehner Abrasion value of not more than about 3.5 mg when measured at 43.5 krev and a solids content of 10%.

6. The calcined kaolin according to claim 5, having an Einlehner Abrasion value of not more than about 3.0 mg when measured at 43.5 krev and a solids content of 10%.

7. The calcined kaolin according to claim 6, having an Einlehner Abrasion value of not more than about 2.0 mg when measured at 43.5 krev and a solids content of 10%.

8. The calcined kaolin according to claim 1, having a Hunter “a” value of less than about 0.1.

9. The calcined kaolin according to claim 8, having a Hunter “a” value of less than zero.

10. The calcined kaolin according to claim 1, having a particle size distribution of over 90% of particles with an equivalent spherical diameter of less than about 2 μm.

11. The calcined kaolin according to claim 1, having a median particle size (D50) of less than about 1 μm.

12. The calcined kaolin according to claim 11, having a median particle size (D50) of less than about 0.5 μm.

13. The calcined kaolin according to claim 1, wherein the calcined kaolin comprises metakaolin.

14. A calcined kaolin, having a Hunter “a” value of less than about 0.1 and an Einlehner Abrasion value of not more than about 4.0 mg when measured at 43.5 krev and a solids content of 10%.

15. The calcined kaolin according to claim 14, having a Hunter “a” value of less than about 0.05.

16. The calcined kaolin according to claim 15, having a Hunter “a” value of less than zero.

17. The calcined kaolin according to claim 14, having a Hunter “b” value of less than about 4.0.

18. The calcined kaolin according to claim 14, having a Hunter “L” value of greater than about 96.0.

19. The calcined kaolin according to claim 14, having an Einlehner Abrasion value of not more than about 3.0 mg when measured at 43.5 krev and a solids content of 10%.

20. The calcined kaolin according to claim 19, having an Einlehner Abrasion value of not more than about 2.0 mg when measured at 43.5 krev and a solids content of 10%.

21. The calcined kaolin according to claim 14, having a particle size distribution of over 90% of particles with an equivalent spherical diameter of less than about 2 μm.

22. The calcined kaolin according to claim 14, having a median particle size (D50) of less than about 1 μm.

23. The calcined kaolin according to claim 22, having a median particle size (D50) of less than about 0.5 μm.

24. The calcined kaolin according to claim 14, wherein the calcined kaolin comprises metakaolin.

25. A method of making a calcined kaolin, comprising
coating at least a portion of a feed kaolin with a fuel composition comprising a liquid fuel to form a coated kaolin; and
heating the coated kaolin to calcine the kaolin and to burn the liquid fuel to form the calcined kaolin,
wherein the calcined kaolin has a GE brightness of at least about 89 and an Einlehner Abrasion value of not more than about 4.0 mg when measured at 43.5 krev and a solids content of 10%.

26. The method according to claim 25, wherein the calcined kaolin has a GE brightness of at least about 90.

27. The method according to claim 26, wherein the calcined kaolin has a GE brightness of at least about 91.

28. The method according to claim 25, wherein the calcined kaolin has an Einlehner Abrasion value of not more than about 3.0 mg when measured at 43.5 krev and a solids content of 10%.

29. The method according to claim 28, wherein the calcined kaolin has an Einlehner Abrasion value of not more than about 2.0 mg when measured at 43.5 krev and a solids content of 10%.

30. The method according to claim 25, wherein the calcined kaolin has a Hunter “a” value of less than about 0.1.

31. The method according to claim 30, wherein the calcined kaolin has a Hunter “a” value of less than zero.

32. The method according to claim 25, wherein the calcined kaolin has a particle size distribution of over 90% of particles with an equivalent spherical diameter of less than about 2 μm.

33. The method according to claim 25, wherein the calcined kaolin has a median particle size (D50) of less than about 1 μm.

34. The method according to claim 33, wherein the calcined kaolin has a median particle size (D50) of less than about 0.5 μm.

35. The method according to claim 25, wherein the calcined kaolin comprises metakaolin.

36. The method according to claim 25, wherein the feed kaolin has a particle size distribution of about 95-100% of particles with an equivalent spherical diameter of less than about 1 μm.

37. The method according to claim 25, wherein the feed kaolin has a particle size distribution of about 80-90% of particles with an equivalent spherical diameter of less than about 0.5 μm.

38. The method according to claim 25, wherein the feed kaolin has a GE brightness of at least about 75.

39. The method according to claim 25, wherein the feed kaolin has a Fe₂O₃ content of about 0.1-1.0% by weight and a TiO₂ content of about 0.1-2.5% by weight.

40. The method according to claim 25, wherein the liquid fuel comprises a hydrocarbon oil.

41. The method according to claim 40, wherein the hydrocarbon oil is chosen from fuel oils, vegetable oils, modified vegetable oils, waste oils, aliphatic and aromatic alcohols, and biodiesels.

42. The method according to claim 41, wherein the fuel oils are chosen from petroleum, mineral oil, turpentine, kerosene, gasoline, diesel, No. 2 fuel oil, No. 4 fuel oil, No. 5 light fuel oil, No. 5 heavy fuel oil, and No. 6 fuel oil.

43. The method according to claim 41, wherein the vegetable oils are chosen from canola oil, soybean oil, corn oil, palm oil, olive oil, sunflower oil, cottonseed oil, peanut oil, sesame oil and safflower oil.

44. The method according to claim 41, wherein the modified vegetable oils are chosen from methyl-, ethyl-, propyl-, and butyl esters of canola oil, soybean oil, corn oil, palm oil, olive oil, sunflower oil, cottonseed oil, peanut oil, sesame oil and safflower oil.

45. The method according to claim 41, wherein the waste oils are chosen from waste fat, grease oil, motor oil, and biodiesel of waste oils.

46. The method according to claim 25, wherein at least about 80% of the kaolin is coated with the liquid fuel.

47. The method according to claim 46, wherein at least about 90% of the kaolin is coated with the liquid fuel.

48. The method according to claim 25, wherein the liquid fuel is present in the coated kaolin in an amount ranging from about 0.01% to about 4% by weight, relative to the total weight of the coated kaolin.

49. The method according to claim 48, wherein the liquid fuel is present in the coated kaolin in an amount ranging from about 0.1% to about 10% by weight, relative to the total weight of the coated kaolin.

50. The method according to claim 25, wherein the coating comprises coating in a mixer.

51. The method according to claim 25, wherein the coating comprises subjecting the kaolin and the fuel composition to a rotational speed of up to about 4,000 rpm.

52. The method according to claim 51, wherein the rotational speed ranges from about 2,000 to about 3,500 rpm.

53. The method according to claim 50, wherein the coating comprises subjecting the kaolin and the fuel composition in the mixer to a tip speed of less than about 10,000 feet per minute.

54. The method according to claim 25, wherein the heating comprises heating at a temperature ranging from about 500° C. to about 1250° C. for a time sufficient to at least partially dehydroxylate the kaolin.

55. The method according to claim 54, wherein the heating comprises heating at a temperature ranging from about 900° C. to about 1200° C. for a time sufficient to at least partially dehydroxylate the kaolin.

56. The method according to claim 55, wherein the heating comprises heating at a temperature ranging from about 950° C. to about 1150° C. for a time sufficient to at least partially dehydroxylate the kaolin.

57. The method according to claim 56, wherein the heating comprises heating at a temperature ranging from about 1000° C. to about 1100° C. for a time sufficient to at least partially dehydroxylate the kaolin.

58. The method according to claim 25, wherein the calcined kaolin comprises partially calcined kaolin.

59. The method according to claim 25, wherein the calcined kaolin comprises fully calcined kaolin.

60. The method according to claim 25, wherein the calcined kaolin comprises flash calcined kaolin.

61. The method according to claim 25, wherein the calcined kaolin comprises mullite.

62. The method according to claim 25, wherein the heating is performed by using at least one of a rotary kiln, a vertical kiln, a flash calciner and a tunnel kiln.

63. A product, comprising a calcined kaolin, wherein the calcined kaolin has a GE brightness of at least about 89 and an Einlehner Abrasion value of not more than about 4.0 mg when measured at 43.5 krev and a solids content of 10%.

64. A product, comprising a calcined kaolin, wherein the calcined kaolin has a Hunter “a” value of less than about 0.1 and an Einlehner Abrasion value of not more than about 4.0 mg when measured at 43.5 krev and a solids content of 10%.

65. A coated paper, comprising the product of claim 63.

66. A coated paper, comprising the product of claim 64.
